(19) United States
(12) Patent Application Publication
(10) Pub. No.: US 2020/0005363 A1
(43) Pub. Date: Jan. 2, 2020

(54) System, Method, Device And Network Architecture For Social Network Giving

(71) Applicant: inLieu LLC, Austin, TX (US)

(72) Inventor: Kathy Terry, Austin, TX (US)

(21) Appl. No.: 16/024,965

(22) Filed: Jul. 2, 2018

(51) Int. Cl. G06Q 30/02; H04L 12/58; G06Q 20/10; H04W 4/14; G06Q 50/00

(52) U.S. Cl. CPC G06Q 30/0279; H04L 51/32; G06F 3/04842; H04W 4/14; G06Q 50/01; G06Q 20/102

(57) ABSTRACT

In one example, a social giving network is configured to execute a method, including: providing, via at least one user interface for display on a display of a device of a user, a first field to receive honoree information of an honoree for a donation to be made to a charitable organization by the user; providing, via the at least one user interface, a second field to receive an identification of the charitable organization and a third field to receive donation information regarding the donation; providing, via the at least one user interface, a fourth field to receive a personalized message for the honoree from the user; and communicating at least a portion of the honoree information, the donation information, the identification of the charitable organization and the personalized message to a remote server associated with a service provider, to enable the service provider to effect the donation to the charitable organization and electronically send the personalized message to the honoree.

### BACKGROUND

Many charitable organizations rely on donations from individuals to fund their missions in whole or in part. Charitable organizations may receive such donations in response to direct mail requests or other directed fund drives. Additional donations may be received via online giving such as directly through a charitable organization's website. While such website-based giving is available, it is typically burdensome for a user to navigate and successfully make a donation. A need exists to better leverage technology to increase charitable giving.

### SUMMARY OF THE INVENTION

In one aspect, a method includes: providing, via at least one user interface for display on a display of a device of a user, a first field to receive honoree information of an honoree for a donation to be made to a charitable organization by the user; providing, via the at least one user interface, a second field to receive an identification of the charitable organization and a third field to receive donation information regarding the donation; providing, via the at least one user interface, a fourth field to receive a personalized message for the honoree from the user; and communicating at least a portion of the honoree information, the donation information, the identification of the charitable organization and the personalized message to a remote server associated with a service provider, to enable the service provider to effect the donation to the charitable organization and electronically send the personalized message to the honoree.

In an example, the method further includes providing the third field and the fourth field on a single screen of the at least one user interface, the user interface of an application in execution on the device. In addition the method may further send the honoree information to the remote server to enable the remote server to access a first database to obtain identification information of one or more charitable organizations associated with the honoree, the identification information provided to the remote server by the honoree and stored in a profile entry of the first database. The method also may include receiving the identification information of the one or more charitable organizations in the device, where to provide the second field comprises to populate the second field with information regarding the one or more of the charitable organizations associated with the honoree. The method may also include providing, via the at least one user interface, a selectable item to enable the user to share information regarding the donation via a live feed of a social network. The method may also include establishing a secure session between the device and the remote server, prior to the communication of the at least the portion of the donation information. The method may also include receiving a confirmation of the donation from the remote server, and displaying on the display an indication of successful completion of a transaction for the donation. The method may also include accessing a contact database of the user to enable the user to select the honoree from the contact database, where an entry of the contact database associated with the honoree includes an indication that the honoree is registered with the service provider.

In another aspect, a remote server may be coupled to a plurality of client devices. This remote server may include: a processor to execute instructions; a communication circuit coupled to the processor; and a memory coupled to the processor. This memory may store instructions that when executed by the processor, cause the processor to: receive, in a client application programming interface in execution on the server, a request to perform a donation transaction between a user of a first client device and a charitable organization mediated by a service provider, the donation transaction in lieu of a gift to a third party; in response to the request, access a database coupled to the remote server to determine one or more charitable organizations identified by the third party and send a list of the one or more charitable organizations to the first client device, to enable the first client device to display the list on a display of the first client device; receive, in the client application programming interface, first information to identify one of the one or more charitable organizations selected by the user for the donation transaction, second information regarding the donation transaction, and third information comprising a personalized message from the user to be sent to the third party; send the personalized message from the remote server to a second client device associated with the third party; and process the donation transaction to enable payment of the donation to the one of the one or more charitable organizations.

In an example, the memory further is to store instructions that when executed by the processor cause the processor to receive the second information and the third information in response to user input provided into a plurality of fields of a single screen of a user interface displayed on the display of the first client device. The memory may further store instructions that when executed by the processor cause the processor to send the personalized message from the remote server to the second client device via a short messaging service application programming interface in execution on the remote server. Also the memory may store instructions that when executed by the processor cause the processor to send the personalized message from the remote server to the second client device via email via an email application programming interface in execution on the remote server. The memory can further store instructions that when executed by the processor cause the processor to: receive, in the client application programming interface, registration information associated with the third party, the registration information comprising an identification of the one or more charitable organizations; and populate an entry in the database associated with the third party, the entry comprising the identification of the one or more charitable organizations.

Note that the user interface may be of a downloadable application in execution on the first client device. In such case, the memory may further store instructions that when executed by the processor cause the processor to provide, through the downloadable application, an interface to allow the user to access, via the first client device, a remote database having identification information for a plurality of charitable organizations, to enable the user to select a different charitable organization for the donation transaction between the user and the different charitable organization mediated by the service provider, the remote database remote from and independent of the remote server.

In yet another aspect, an apparatus includes: a client module configured to receive a request to perform a donation transaction between a user of a first client device coupled to the apparatus and a charitable organization mediated by a service provider, the donation transaction in lieu of a gift to a third party, the client module further configured to receive first information to identify a first charitable organization selected by the user for the donation transaction, second information regarding the donation transaction, and third information comprising a personalized message from the user to be sent to the third party; a database module configured to access a database coupled to the apparatus to determine, based on an identification of the third party, a list of one or more charitable organizations identified by the third party, the list of one or more charitable organizations including the first charitable organization, and send the list to the client module for delivery to the first client device, to enable the first client device to display the list on a display of the first client device; a short messaging service module to send the personalized message from the apparatus to a second client device associated with the third party, when the second client device is a mobile phone; an email module to send the personalized message from the apparatus to the second client device associated with the third party, when the second client device is not a mobile phone; and an orchestration module to enable interaction between the client module, the short messaging service module and the email module.

The apparatus may further include a social network module to generate a live feed of donation transactions, the social network module to include a posting in the live feed based on the donation transaction. The social network module may receive a second request from another user of another client device coupled to the apparatus to perform a second donation transaction between the second user and the charitable organization in response to the posting in the live feed. In turn, the orchestration module may provide information regarding the donation transaction to a workforce giving entity to enable a match donation to be made by an employer of the user via the workforce giving entity. The client module may receive the second information and the third information in response to user input provided to a plurality of fields of a single screen of a user interface displayed on the display of the first client device.

### BRIEF DESCRIPTION OF THE DRAWINGS

FIG. 1 is a flow diagram of a method in accordance with one embodiment of the present invention.

FIG. 2 is a flow diagram of a method in accordance with another embodiment of the present invention.

FIG. 3 is a flow diagram of a method in accordance with yet another embodiment of the present invention.

FIG. 4 is a flow diagram of a method for interacting between a service provider and a client device of a gift recipient in accordance with one embodiment of the present invention.

FIG. 5 is a flow diagram of a method in accordance with a further embodiment of the invention.

FIG. 6 is a block diagram of a network architecture in accordance with an embodiment of the present invention.

FIG. 7 is a block diagram of a client device system in accordance with an embodiment of the present invention.

FIG. 8 is an example graphical user interface in accordance with one embodiment of the present invention.

FIG. 9 is an example graphical user interface in accordance with another embodiment of the present invention.

### DETAILED DESCRIPTION

In various embodiments, a platform is provided to enable social giving. More specifically, embodiments provide a platform that allows a user to make a donation or other gift to a charitable organization that honors another person or persons, such as one or more friends of the user. The person or persons on behalf of whom a gift is made are referred to herein as “honoree” or “recipient.” More specifically, embodiments of a platform enable a user to give a gift to a charitable organization “in lieu” of a gift to the person or persons. Embodiments enable a user to make a donation in lieu of purchasing a gift and at the same time make donating fast, easy and social. The platform also is configured to provide a social network including a live social feed of transactions that can be liked and shared with friends, allowing users to support friends by supporting their causes, in a manner that makes donating social, and readily accessible by a user via the computing architectures and techniques described herein.

Embodiments further leverage the platform to enable a user, in a single transaction, to make a donation and further provide a personalized message to the honoree. As such, in a single interaction with a single application (“app”) that executes on a mobile device, web-based portal or so forth, the user can provide all information to make the donation to the charitable organization and at the same time and within the same transaction, provide a personalized message to be sent to the honoree(s).

Although embodiments are not limited in this regard, typical implementations may be by way of a downloadable app that is stored in a non-transitory storage medium of a mobile device, e.g., of a user. When the user opens the app, one or more user interfaces are provided on a display of the mobile device to enable the user to provide information that allows the transaction to proceed and a personalized message to be sent. To this end, the app may be configured to send the provided information to a remote server, e.g., a cloud-based server such as one or more servers associated with a provider of the app.

This remote server in turn is configured to interact with the user via the app to obtain all appropriate information to enable the transaction and the personalized message to be generated. In addition, the remote server may be configured to process the transaction, e.g., by way of backend credit card processing or processing by way of another payment source, such as a Paypal™ account, Apple Pay™, Samsung Pay™, Google Pay™ or so forth. This payment processing includes, in addition to receiving and authenticating payment information from the user, performing merchant processing to obtain the donated amount and any administrative and/or additional service fees. Still further this payment processing also includes providing the donated amount to the charitable organization. The remote server may still further be configured to receive the personalized message and provide the message to the intended recipient, such as via a short messaging service (SMS) text message, email message via an email server system or so forth.

Thus in various embodiments, a user is allowed to readily make a donation and provide a personalized message to an honoree concurrently in a single transaction. In contrast, available donation systems do not provide the ability for a user to concurrently execute a donation transaction and send a personalized message to a gift recipient. Rather, in these systems while a user may make a donation, e.g., via a website mechanism, there is no ability to at the same time to provide a personalized message to the gift recipient.

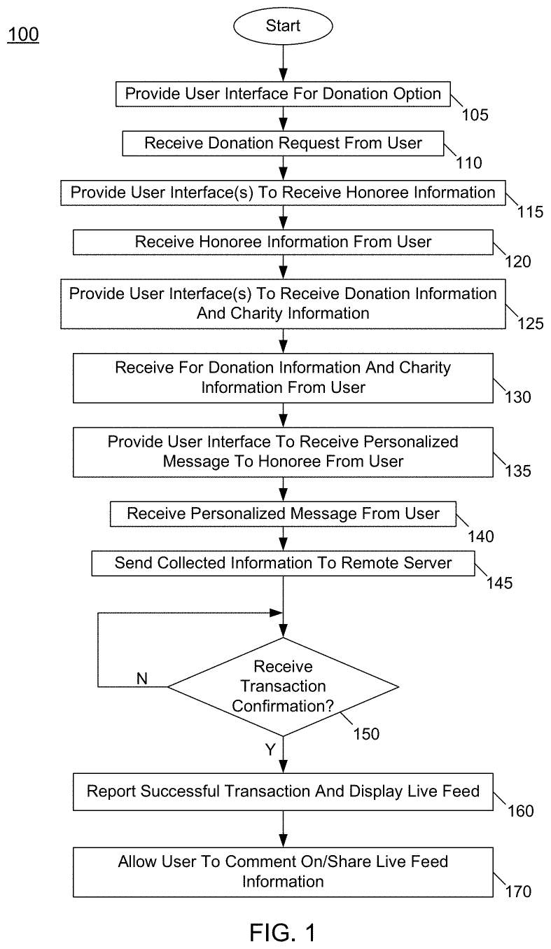

Referring now to FIG. 1, shown is a flow diagram of a method in accordance with one embodiment of the present invention. As shown in FIG. 1, method 100 is a method for interacting with a user via a device such as a mobile device for realizing social giving via a donation transactions. In embodiments, method 100 may be performed by hardware circuitry, software, firmware and/or combinations thereof. In a particular embodiment, method 100 may be implemented via an app that executes on one or more processors of the mobile device and interacts with the user via one or more user input/output (I/O) devices, including a touchscreen, microphone or other device.

As illustrated, method 100 begins by providing a user interface for a donation option (block 105). Such donation option may be one of multiple options available from which a user can select. For example, options may include a donation option, an event planning option and a direct gift option, among additional options such as housekeeping options regarding the user's account. Note that with an event planning option, a user may plan an event such as a party, and identify a charity. In turn when an invitee accesses an online invitation, he or she is also invited to donate to the charity, e.g., using an application as described herein.

Still referring to FIG. 1, in response to the donation option user interface, the app may receive a user selection for making a donation request via the donation option (block 110). Next, control passes to block 115, where one or more user interfaces may be provided to receive honoree information. This honoree information may be sought by way of user input of a person's name. For example, a user may access the name by searching through an address book or other contact information available on the mobile device or accessible via a social media platform such as Facebook™, Snapchat™ or so forth.

Control next passes to block 120 where the honoree information is received. Thereafter at block 125, within the same interface or one or more additional user interfaces, donation information and charity information may be received. Understand that this information may include an identification of the charitable organization as well as an amount of money to be donated. Additional information such as payment information and so forth also may be received via these one or more user interfaces. Further, as discussed in more detail below, it is possible for the app by way of such user interfaces to auto-populate selected charitable organizations, such as those associated with the honoree, the user or made available via an organization search, as examples. In any event, control passes to block 130 where the donation information and honoree information are received from the user.

Next control passes to block 135 where a user interface is provided to receive a personalized message for the honoree from the user. Note that it is possible for this personalized message to be generated within the same one or more user interfaces as discussed herein. Certainly, this personalized message is received as part of a single transaction that executes on a single app. As an example, the user interface may provide a dialog field to enable input of the personalized message, which the user may provide by way of touchscreen input, voice input or so forth. Note further that embodiments provide this one or more user interface (and which may be a single user interface) in a manner capable of full display on small displays of mobile devices such as smartphones, cellphones, or so forth. In this way, a user can interact as described herein, providing all details with regard to honoree, charity, donation information and personalized message, in a single user interface. As such this single user interface permits interaction with a greater amount of information, including fields not previously available in gifting, and which is particularly suitable for effecting transactions on a small display of a mobile computing/communication device. In this way, via one or more user interfaces as described herein, a user can interact with a single application in execution on the mobile computing/communication device to result in a gift transaction to a charitable organization (as mediated by a service provider) on behalf of an honoree, and a personalized message to be sent to the honoree (again as mediated, in at least some cases, by the same service provider).

In some embodiments, in addition to the personalized message, additional parameters regarding the message, such as a desired means of transmission (e.g., text message or email) also may be sought from the user via the user interface. Or in another embodiment, the communication mechanism can be automatically determined based on the available contact information for the honoree (e.g., when the honoree information includes a mobile phone number, the message will be sent by text message). Control passes then to block 140 where this personalized message is received.

Control next passes to block 145 where the collected information is sent to a remote server, namely a remote server associated with the app provider (also referred herein as a “service provider”). Such remote server may be implemented via one or more cloud-based servers. Understand that while FIG. 1 generally shows a serial flow of the providing of user interfaces and receiving of information, other orders of providing the received information to the remote server, or other processing flows are possible. For example, after each user input, collected information may be parsed within the app and forwarded along to the remote server. In embodiments, the mobile device may connect with the remote server in a secure session, e.g., via the Internet, such that security of the payment information is maintained.

Still referring to FIG. 1, next it is determined whether a transaction confirmation is received (diamond 150). For example, the app may receive a confirmation from the remote server that it has received all needed information and has begun processing of the gift transaction (and may optionally seek the user's confirmation in order to finalize the transaction). Next at block 160 this successful transaction may be reported to the user, e.g., via a touchscreen. Furthermore, a live feed of the gift transaction may be displayed in a live feed maintained by the app provider. In addition, at block 170 the user is allowed to comment on and/or share the live feed information regarding this donation, which may possibly lead to additional donations to be made by others on behalf of the same honoree (or others) and to the same charitable organizations (or others). Understand while shown at this high level in FIG. 1, many variations and alternatives are possible. As one example, while another user can click on a posting in a live feed in order to easily make a donation via auto population of various fields, other techniques can be used to leverage information from one transaction for another transaction. Assume a user shares a gift or donation from the live feed. In this case, a link is generated that, when accessed by another user that receives the link, causes a device of that user to proceed directly to the gifting/donating detail within the app, reducing time and complexity in making a new donation.

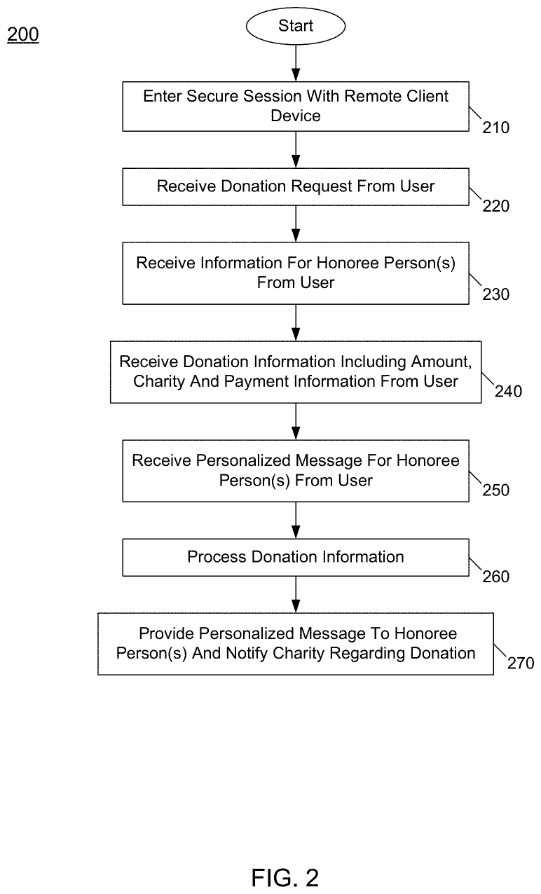

Referring now to FIG. 2, shown is a flow diagram of a method in accordance with another embodiment of the present invention. As shown in FIG. 2, method 200 is a method for effecting social giving, from the point of view of a remote server in communication with a user computing device. As such, method 200 may be performed by hardware circuitry, software, firmware and/or combinations thereof. Method 200 begins by entering into a secure session with a remote client device (block 210). Such secure session may be set up in response to a user access to the app via entry of a username and password or other login information. Next a donation request is received from the user (block 220). As discussed above, this donation request is in response to a user interface that enables the user to select a social network gift option. Control then passes to block 230 where information for one or more honorees is received from the user. Such information may include a name of the honoree and contact information, e.g., in the form of a mobile phone number and/or email address, in addition to possibly additional information such as a home or work address. Next, control passes to block 240 where donation information is received. In the embodiment shown in FIG. 2, such information may include amount, charity and payment information. Still with reference to FIG. 2, at block 250 a personalized message may be received for the honoree from the user.

Thereafter, at block 260 the donation information is processed. For example, the remote server may include or be associated with a merchant processing server so that the donation amount and any service charges can be charged to a credit card or other account of the user. Furthermore, additional payment processing may occur to enable allocation of the donation amount to the appropriate charity to enable the service provider to a make payment to the charity. Still with reference to FIG. 2, at block 270 the personalized message may be provided to the honoree(s). The personalized message can be sent from the remote server to the honoree, e.g., via SMS message through a messaging server and/or via email using an email server. In addition, the charity may be notified regarding the donation. Similarly, notification to the charity regarding the donation may be effected via an email notification. Although shown at this high level in the embodiment of FIG. 2, many variations and alternatives are possible.

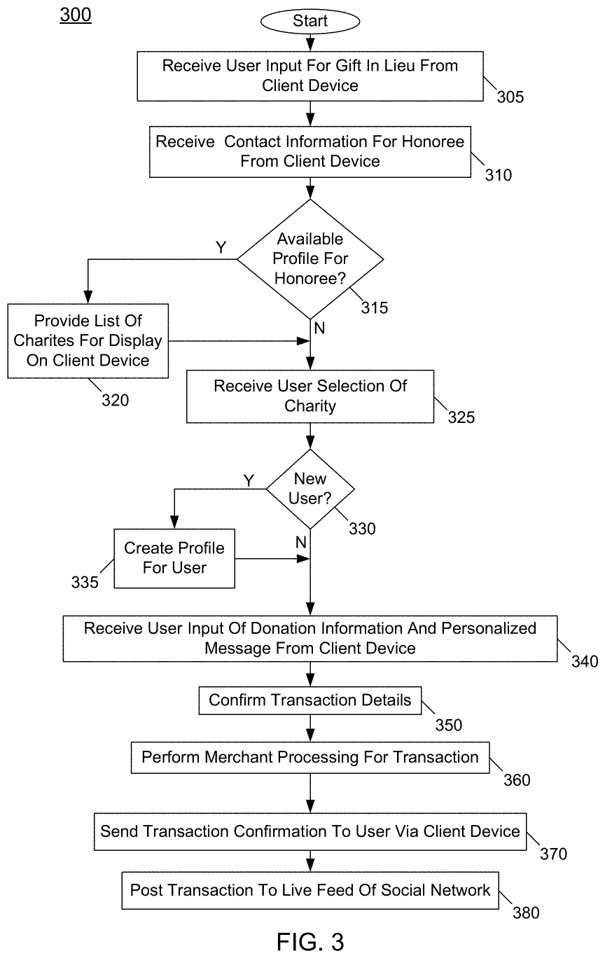

Referring now to FIG. 3, shown is a flow diagram of a method in accordance with yet another embodiment of the present invention. As shown in FIG. 3, method 300 is a method for processing an in lieu gift in a service provider server in response to information received from a client device with which the service provider server is in communication, and which may be performed by hardware circuitry, software, firmware and/or combinations thereof.

As illustrated, method 300 begins by receiving a user input for a gift in lieu from a client device (block 305). Such request is received from the client device, e.g., a mobile device, in response to the user opening the gift application and selecting a gift option. Next control passes to block 310, where contact information may be received from the client device regarding the honoree. As described above, this honoree information may be obtained via user selection of a contact within a contact list or database of the client device. Or a user may provide contact information for the honoree, which may include name and contact information, or other username for the user such as an Instagram™, Facebook™, or Twitter™ handle.

Still with reference to FIG. 3, next it is determined at diamond 315 whether there is an available profile for the honoree. The server may access a user database to determine whether the honoree has provided a profile for the application. If so, at block 320 the server can provide a list of charities for display on the client device. Note that this list of charities may be provided by pre-population of selectable fields in one or more user interfaces for one or more of charities that are identified in the honoree profile, which the honoree may provide during a registration process. Next, at block 325 a user selection of a charity is received. For example, the user may select a pre-populated charity or provide information regarding the charity. In some cases, the user may access a third party database of charities such as a Guidestar™ database in order to identify the charity.

Control next passes to diamond 330 to determine whether the user is a new user. If so, at block 335 a profile may be created for the user. This user information may be stored in an entry for the user within a user or profile database, including as examples name (and/or username), cell phone number, email address and residence address, payment (e.g., credit card or online account), a list of charities to allow others to make gift donations on behalf, and other information.

Next, control passes to block 340 where the server may receive donation information and a personalized message. As described above, this information may be received via a single screen of a user interface of the application presented on the client device, such that the user can seamlessly provide both the donation information a personalized message for the honoree.

Still referring to FIG. 3, the server may confirm transaction details (block 350), e.g., by sending details including donation amount, charity and honoree to the client device to enable the client device to display this information and optionally receive confirmation of the transaction from the user before further processing.

Still with reference to FIG. 3, at block 360 merchant processing for the transaction may be performed. For example, a merchant processing API of the server may be in communication with a server of a credit card merchant to process the transaction. Next at block 370 a transaction confirmation can be sent to the user via the client device. Finally, at block 380 information regarding the transaction can be posted to a live feed of a social network, e.g., a social network of the service provider. This live feed may be a continually updated listing of gift transactions that have occurred. Note that in some cases, the user may prevent this information from being shared with an entire community. Or the user may enable only friends to view transaction information, depending on user settings. Although shown at this high level in the embodiment of FIG. 3, many variations and alternatives are possible.

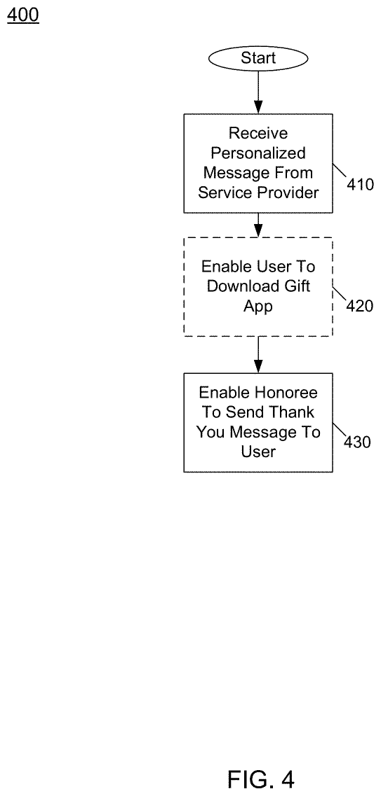

Referring now to FIG. 4, shown is a flow diagram of a method for interacting between service provider and client device of a recipient of gift, namely an honoree, in accordance with one embodiment of the present invention. To this end, method 400 is illustrated from the point of view of a client device of the honoree, e.g., a mobile device, and thus may be performed by hardware circuitry, software, firmware and/or combinations thereof. As illustrated at block 410, this client device receives a personalized message from the service provider regarding a gift in lieu. For example, the client device may receive a text message or email. This message includes the personalized message from the user who made the donation, and optionally a link that may be used to access an application repository or other service to enable a download of the application or access to a website of the service provider (optional block 420). In some cases, this link itself or an additional link may be used to provide a link to the live feed of the social network.

With further reference to FIG. 4, at block 430 the client device may enable the honoree to send a thank you message to the user. As an example, when the mobile device is in execution of the application, an option may be presented to enable this thank you message to be sent, which itself can be personalized. Or in another case the user may access the information regarding the donation in the live feed of the social network to send a thank you message to the user. In this way, the honoree provides this thank you message through the service provider and to a device of the user, to enable the user to confirm that the honoree has been informed of the donation. Although shown at this high level in the embodiment of FIG. 4, many variations and alternatives are possible.

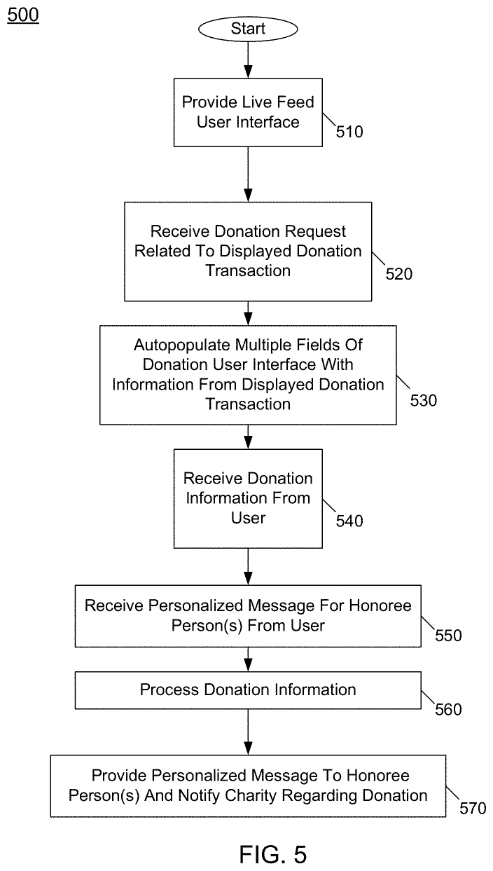

Referring now to FIG. 5, shown is a flow diagram of a method in accordance with a further embodiment of the invention. More specifically, method 500 is a method for maintaining a social network of a service provider and providing a live feed of information regarding gift donations made in lieu. Method 500 may be executed via one or more server computers of the service provider, and may be performed by hardware circuitry, software, firmware and/or combinations thereof. As illustrated, method 500 begins by providing a live feed user interface (block 510). This live feed may include information regarding donation transactions, including giver, recipient and charity, as well as potentially other information for sharing, including a brief message regarding the reason for the gift (e.g., birthday gift, gift in honor of an event or so forth), and an ability to comment on a transaction. This live feed user interface may be accessible to many different users via a variety of different client devices.

Embodiments enable increased donations with the ease of making donations using the techniques described herein. In one particular embodiment, a user may leverage information in a donation transaction displayed on the live feed to make an additional donation. Thus as further seen in FIG. 5, at block 520 a donation request may be received that is related to a displayed donation transaction. For example, assume that the live feed includes information regarding a first donation transaction made on behalf of an honoree to a first charity in honor of the honoree's birthday. As such, this live feed-initiated donation request may be from another user viewing the live feed. And the request may be for another donation to be given to the same charity on behalf same honoree (and for the same reason (e.g., birthday)). Accordingly, at block 530 multiple fields of a donation user interface can be auto-populated. More specifically, fields for (at least) the charity and honoree can be auto-populated using the live feed information. Next, at block 540 donation information may be received from the user. As discussed above, this donation information may include an amount of the donation and payment information. Next a personalized message may be received from the user, as described above (block 550). Then at block 560 the donation information is processed, such as described above. At block 570 the personalized message may be provided to the honoree(s) and the charity may be notified regarding the donation. Although shown at this high level in the embodiment of FIG. 5, many variations and alternatives are possible.

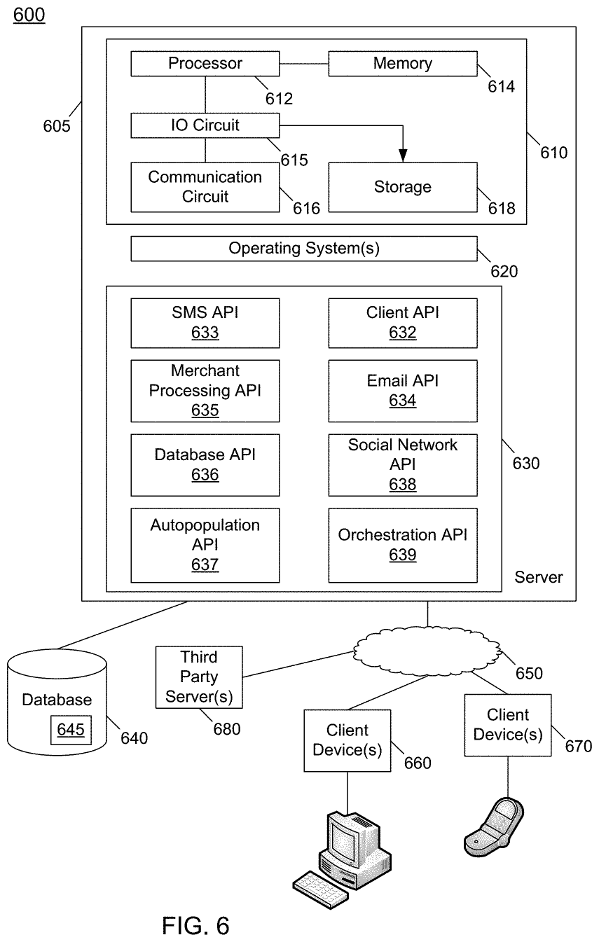

Referring now to FIG. 6, shown is a block diagram of a network architecture in accordance with an embodiment of the present invention. More specifically, FIG. 6 illustrates a computer network 600 including a server of a service provider, namely server 605 that is in communication with, e.g., a database 640, which may be a local database of the service provider. Database 640 may include a repository to store downloadable apps such as app 645, e.g., a gift application as described herein. As such server 605 may provide app 645 to users in response to download requests. Note further that app 645 also may be available on third party app repositories such as the Apple Store™ or Google Play™. In different implementations, database 640 may be communicatively coupled to server 605 and/or may be a separate database of a given storage network to which server 605 may be coupled, e.g., via a database server.

As further illustrated, server 605 may communicate with other computing devices via a network 650, e.g., the Internet. Server 605 may communicate with a variety of different types of client devices, including client devices 660 which may be personal computers such as notebook computers or desktop computers. Server 605 also may communicate with mobile devices 670 such as smart phones, tablet computers, or other mobile Internet devices. In addition, server 605 may communicate with one or more third party servers 680. As examples, such third party servers may be associated with merchant processors, third party charitable organizations, charitable organization database providers or so forth.

Still with reference to FIG. 6, representative details of server 605 are shown. Specifically, FIG. 6 shows an arrangement including hardware circuitry, software and/or firmware that enables remote server 605 to execute typical computing operations and further to perform operations described herein, including the receipt and processing of donations received from users and fulfilling such donations, in addition to providing personalized messages from the users to gift recipients (e.g., honorees) as described herein. As illustrated, server 605 includes hardware 610 including at least one processor 612, which may be one or more general-purpose processors or systems on chip. In turn, processor 612 is coupled to a memory 614 which may be a dynamic random access memory (DRAM) or other volatile memory. Processor 612 further couples via an input/output (IO) circuit 615 to peripheral devices, including a storage 618 such as a mass storage device, e.g., one or more disk drives, flash memories, solid state drives or so forth. In addition, IO circuit 615 couples to a communication circuit 616. Communication circuit 616 may include one or more communication interfaces to enable both wired and wireless communications with other devices.

As further shown in FIG. 6, one or more operating systems 620 are present, which may execute on processor 612. In addition, a software and/or firmware layer 630 also is present. In embodiments herein, layer 630 may include various programming modules, each including a set of instructions to be executed by underlying hardware (e.g., processor 612), to effect the operations described herein. As illustrated, layer 630 may include various application programming interfaces (APIs) or other program modules that enable interaction between server 605 and other computing devices. As seen, a client API 632 may include instructions that when executed enable server 605 to interface with one or more client devices (e.g., devices 660, 670) to handle donations, perform account creations, user profile updates and so forth. An email API 634 may include instructions that when executed enable communication of email messages, e.g., to honorees in response to received personalized messages to be delivered by email, as well as sending email messages to charitable organizations and/or users advising regarding donation transactions. In turn, an SMS API 633 may include instructions that when executed enable communication of text messages, e.g., to honorees in response to received personalized messages to be delivered by text.

Still referring to FIG. 6, a merchant processing API 635 includes instructions that when executed enable server 605 to execute merchant processing with remote third party servers (e.g., a given third party server 680) to perform credit card processing to enable a donation transaction to be effected. A database API 636 includes instructions that when executed enable server 605 to interface with database 640, e.g., to access details of a user profile stored in database 640, as well as to store information regarding donation transactions and so forth. By way of database API 636, a historical database is maintained within database 640 that stores a history of donation transactions associated with given users. As such, this historical information may be made available to the users (and honorees) to readily identify past transactions, and potentially enable further donations to be made with auto-population of various fields based on the stored information. To this end, an auto-population API 637 includes instructions that when executed enable server 605 to provide auto-population information to client devices in order to allow users to easily obtain information and select, e.g., charitable organizations, honorees, donation amounts and so forth. A social network API 638 includes instructions that when executed by server 605 generate a live feed of donation transactions, which may include information as described herein.

Finally with further reference to FIG. 6, an orchestration API 639 includes instructions that when executed enable server 605 to interact with a variety of different client devices and back end servers according to different communication techniques. Orchestration API 639 is configured to direct incoming information received from a given client device to the various APIs within layer 630. Still further, orchestration API 639 is configured to direct outgoing communications sent back to client devices or back end servers. In addition, orchestration API 639 is further configured to direct messages, as received from a given client device based on user input into a user interface as described herein, to a selected one of, e.g., APIs 633, 634 (namely SMS API 633 in the case of a text message and e-mail API 634 in the case of an e-mail).

Orchestration API 639 also may enable interaction between the service provider and third parties such as workforce giving entities. Such workforce giving entities may be associated with employers or third parties that provide applications and platforms to allow employees to make donations to charities by way of payroll giving. As such, orchestration API 639 may also be configured to act as a bridge or link between third party donation entities and the available resources within layer 630. With this link, users performing a gift to transactions via an application as described herein can have those donations matched by an employer via this link realized between layer 630 and the third party entity, by way of orchestration API 639. In addition, orchestration API 639 can also interact with other third party servers such as a database provider such as Guidestar™, which maintains a database of charitable organizations. Understand while shown at this high level in the embodiment of FIG. 6, many variations and alternatives are possible.

Although the above discussion describes relevant components as APIs, such components may be equally referred to as “modules”, “logic” or “engines,” all of the terms referring to configurations representing a set of executable software instructions and corresponding hardware (e.g., non-transitory storage and one or more processors) for executing the instructions. Understand also that other functional modules and engines that are not germane to conveying an understanding of the embodiments herein matter have been omitted from FIG. 6. Of course, additional functional modules and engines may be used with a social network system, such as that illustrated in FIG. 6, to enable additional functionality not specifically described herein. Furthermore, the various functional modules and engines depicted in FIG. 6 may reside on a single server computer or may be distributed across several server computers in various arrangements, including but not limited to cloud-based solutions that enable interaction in a client-server architecture.

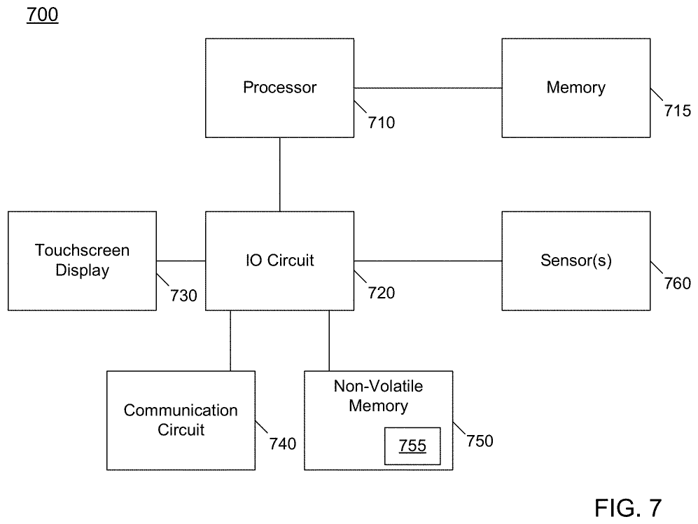

Referring now to FIG. 7, shown is a block diagram of a client device system in accordance with an embodiment of the present invention. More specifically, system 700 is a block diagram of a representative client device, such as a smart phone or other portable computing communication device. As illustrated, system 700 includes a processor 710, e.g., a multicore processor that couples to a memory 715 (which in an embodiment may be a DRAM). Processor 710 in turn couples to an IO circuit 720 to which various devices may couple. As illustrated, IO circuit 720 couples to a touchscreen display 730 which may display user interfaces as described herein, as well as receive user input by way of the touch screen. IO circuit 720 further couples to a communication circuit 740, which may include wireless circuitry to communicate with both short-range and wide area wireless networks, including Bluetooth™, Wi-Fi and cellular networks. Via communication circuit 740, system 700 may be in communication with remote servers, including one or more remote servers of a service provider as described herein. IO circuit 720 further couples to one or more sensors 760. Sensors 760 may include accelerometers, temperature sensors or so forth, as well as environmental sensors, including a microphone, which may receive user voice input.

Still with reference to FIG. 7, IO circuit 720 further couples to a non-volatile memory 750, which in an embodiment may be implemented as a flash memory or other non-volatile storage. As seen, an application 755, such as a downloadable app as described herein to provide secure and easy gift giving of donations to charitable organizations on behalf of gift recipients, is present. Upon download, system 700 may store application 755 in non-volatile memory 750. In operation, processor 710 and/or other components of system 700 may execute application 755 to perform the various operations as described herein.

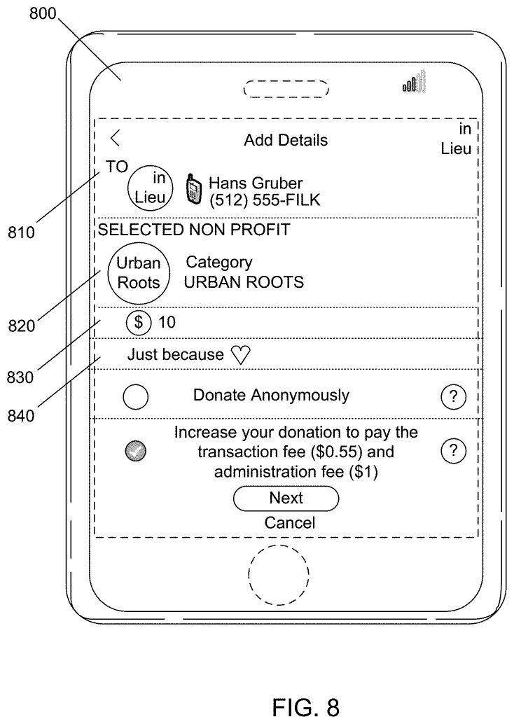

Referring now to FIG. 8, shown is an example graphical user interface in accordance with one embodiment of the present invention. As illustrated in FIG. 8, user interface 800 is a user interface that a user may view on a display of a mobile device on which the gift application as described herein is executing. As seen, via a single screen of user interface 800, a user is presented with a plurality of fields including an honoree field 810, an organization field 820, a gift field 830 and a message field 840, in addition to other fields, selectable buttons and so forth. Thus by way of this single screen of user interface 800, a user may provide contact information for an honoree and charitable organization, as well as providing gift information (e.g., payment amount and optional additional covering costs), as well as a personalized message. As such, a user may efficiently make a gift donation and provide a message to an honoree via this single screen of user interface 800. Understand while this particular representation is shown in FIG. 8, many variations and alternatives are possible.

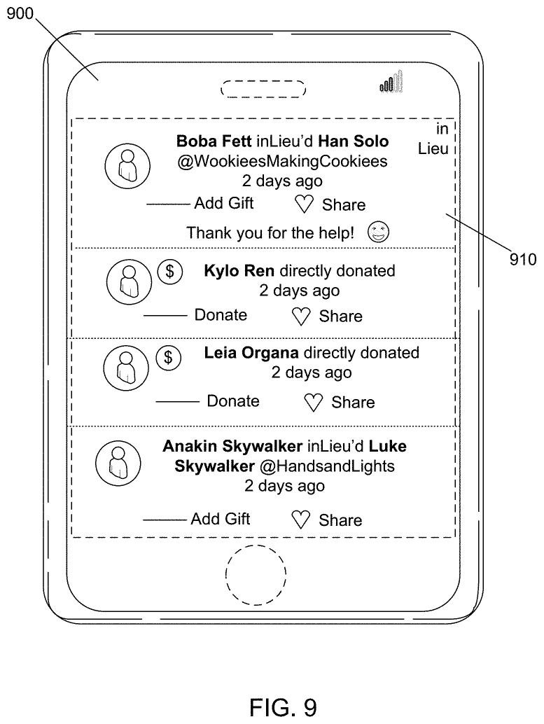

Referring now to FIG. 9, shown is an example graphical user interface in accordance with another embodiment of the present invention. As illustrated in FIG. 9, user interface 900 may be all or a portion of a live feed user interface in which information regarding donations made within the social network can be shown. As seen, a representative posting 910 includes information regarding a donation transaction. As illustrated, posting 910 includes information regarding the giver, gift recipient and charitable organization, as well as information regarding all or a portion of a personalized message, and an ability to select the transaction, e.g., to make another gift to the same organization (which may leverage auto-population of various information from this the transaction in posting 910) and/or to share the information, e.g., via another network. Understand while shown with this example information in the embodiment of FIG. 9, many variations and alternatives are possible.

Certain embodiments include elements that are described herein as components, modules, APIs, logic or engines, among other such terms. Understand that in different embodiments, these elements can be implemented as either software modules (e.g., code embodied on a non-transitory computer-readable storage medium) or hardware modules, which may be general-purpose or specialized hardware. In various example embodiments, one or more computer systems (e.g., standalone computer system, client computer system, or server computer system) or one or more hardware modules of a computer system (e.g., one or more processors, fixed function units or so forth) can be configured by software (e.g., an application or application portion) as a hardware module that executes the operations as described herein. Such hardware modules may include programmable logic or circuitry that is configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer considered general-purpose processors.

As described herein, the performance of certain of the operations may be distributed among processors, not only residing within a single machine, but deployed across a number of machines. In some example embodiments, the processors or processor-implemented modules are located in a single geographic location (e.g., within a mobile or home environment, an office environment, or a datacenter environment). In other example embodiments, the processors or processor-implemented modules are distributed across a number of geographic locations.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A non-transitory computer readable medium comprising instructions that when executed by a processor cause the processor to:
provide, via at least one user interface for display on a display of a device of a user, a first field to receive honoree information of an honoree for a donation to be made to a charitable organization by the user;
provide, via the at least one user interface, a second field to receive an identification of the charitable organization and a third field to receive donation information regarding the donation;
provide, via the at least one user interface, a fourth field to receive a personalized message for the honoree from the user; and
communicate at least a portion of the honoree information, the donation information, the identification of the charitable organization and the personalized message to a remote server associated with a service provider, to enable the service provider to effect the donation to the charitable organization and electronically send the personalized message to the honoree.

2. The non-transitory computer readable medium of claim 1, further comprising instructions that when executed cause the processor to provide the third field and the fourth field on a single screen of the at least one user interface, the user interface of an application in execution on the device.

3. The non-transitory computer readable medium of claim 1, further comprising instructions that when executed cause the processor to send the honoree information to the remote server to enable the remote server to access a first database to obtain identification information of one or more charitable organizations associated with the honoree, the identification information provided to the remote server by the honoree and stored in a profile entry of the first database.

4. The non-transitory computer readable medium of claim 3, further comprising instructions that when executed cause the processor to receive the identification information of the one or more charitable organizations in the device, wherein to provide the second field comprises to populate the second field with information regarding the one or more of the charitable organizations associated with the honoree.

5. The non-transitory computer readable medium of claim 1, further comprising instructions that when executed cause the processor to provide, via the at least one user interface, a selectable item to enable the user to share information regarding the donation via a live feed of a social network.

6. The non-transitory computer readable medium of claim 1, further comprising instructions that when executed cause the processor to establish a secure session between the device and the remote server, prior to the communication of the at least the portion of the donation information.

7. The non-transitory computer readable medium of claim 1, further comprising instructions that when executed cause the processor to receive a confirmation of the donation from the remote server, and display on the display an indication of successful completion of a transaction for the donation.

8. The non-transitory computer readable medium of claim 1, further comprising instructions that when executed cause the processor to cause the device to access a contact database of the user to enable the user to select the honoree from the contact database, wherein an entry of the contact database associated with the honoree includes an indication that the honoree is registered with the service provider.

9. A system comprising:
a remote server to couple to a plurality of client devices, the remote server comprising:
a processor to execute instructions;
a communication circuit coupled to the processor; and
a memory coupled to the processor, the memory to store instructions that when executed by the processor, cause the processor to:
receive, in a client application programming interface in execution on the system, a request to perform a donation transaction between a user of a first client device and a charitable organization mediated by a service provider, the donation transaction in lieu of a gift to a third party;
in response to the request, access a database coupled to the remote server to determine one or more charitable organizations identified by the third party and send a list of the one or more charitable organizations to the first client device, to enable the first client device to display the list on a display of the first client device;
receive, in the client application programming interface, first information to identify one of the one or more charitable organizations selected by the user for the donation transaction, second information regarding the donation transaction, and third information comprising a personalized message from the user to be sent to the third party;
send the personalized message from the remote server to a second client device associated with the third party; and
process the donation transaction to enable payment of the donation to the one of the one or more charitable organizations.

10. The system of claim 9, wherein the memory further is to store instructions that when executed by the processor cause the processor to receive the second information and the third information in response to user input provided into a plurality of fields of a single screen of a user interface displayed on the display of the first client device.

11. The system of claim 9, wherein the memory further is to store instructions that when executed by the processor cause the processor to send the personalized message from the remote server to the second client device via a short messaging service application programming interface in execution on the remote server.

12. The system of claim 9, wherein the memory further is to store instructions that when executed by the processor cause the processor to send the personalized message from the remote server to the second client device via email via an email application programming interface in execution on the remote server.

13. The system of claim 9, wherein the memory further is to store instructions that when executed by the processor cause the processor to:
receive, in the client application programming interface, registration information associated with the third party, the registration information comprising an identification of the one or more charitable organizations; and
populate an entry in the database associated with the third party, the entry comprising the identification of the one or more charitable organizations.

14. The system of claim 9, wherein the user interface is of a downloadable application in execution on the first client device.

15. The system of claim 14, wherein the memory further is to store instructions that when executed by the processor cause the processor to provide, through the downloadable application, an interface to allow the user to access, via the first client device, a remote database having identification information for a plurality of charitable organizations, to enable the user to select a different charitable organization for the donation transaction between the user and the different charitable organization mediated by the service provider, the remote database remote from and independent of the remote server.

16. An apparatus comprising:
a client module configured to receive a request to perform a donation transaction between a user of a first client device coupled to the apparatus and a charitable organization mediated by a service provider, the donation transaction in lieu of a gift to a third party, the client module further configured to receive first information to identify a first charitable organization selected by the user for the donation transaction, second information regarding the donation transaction, and third information comprising a personalized message from the user to be sent to the third party;
a database module configured to access a database coupled to the apparatus to determine, based on an identification of the third party, a list of one or more charitable organizations identified by the third party, the list of one or more charitable organizations including the first charitable organization, and send the list to the client module for delivery to the first client device, to enable the first client device to display the list on a display of the first client device;
a short messaging service module to send the personalized message from the apparatus to a second client device associated with the third party, when the second client device is a mobile phone;
an email module to send the personalized message from the apparatus to the second client device associated with the third party, when the second client device is not a mobile phone; and
an orchestration module to enable interaction between the client module, the short messaging service module and the email module.

17. The apparatus of claim 16, further comprising a social network module to generate a live feed of donation transactions, the social network module to include a posting in the live feed based on the donation transaction.

18. The apparatus of claim 17, wherein the social network module is to receive a second request from another user of another client device coupled to the apparatus to perform a second donation transaction between the second user and the charitable organization in response to the posting in the live feed.

19. The apparatus of claim 16, wherein the orchestration module is to provide information regarding the donation transaction to a workforce giving entity to enable a match donation to be made by an employer of the user via the workforce giving entity.

20. The apparatus of claim 16, wherein the client module is to receive the second information and the third information in response to user input provided into a plurality of fields of a single screen of a user interface displayed on the display of the first client device.
